(19) United States
(12) Patent Application Publication
(10) Pub. No.: US 2026/0016129 A1
(43) Pub. Date: Jan. 15, 2026

(54) PREDICTION OF CORROSION UNDER INSULATION IN PIPES

(71) Applicant: SAUDI ARABIAN OIL COMPANY, Dhahran (SA)

(72) Inventors: Abdulmohsen A. NAFEA, Dhahran (SA); Mohamud M. FARAH, Dhahran (SA); Ibrahim J. ZAHRANI, Dhahran (SA); Hasan A. GHAMDI, Dhahran (SA)

(73) Assignee: SAUDI ARABIAN OIL COMPANY, Dhahran (SA)

(21) Appl. No.: 18/771,830

(22) Filed: Jul. 12, 2024

(51) Int. Cl. F17D 5/00

(52) U.S. Cl. CPC F17D 5/00

(57) ABSTRACT

A system for predicting corrosion under insulation for a network of insulated pipes, vessels, and tanks includes a corrosion modeling engine operable to receive sensor data and generate predicted rates of corrosion. The corrosion modeling engine includes a corrosion rate calculation module operable to compare an operating temperature of an insulated component to a dew point temperature of a surrounding environment to generate a predicted rate of corrosion, and a remaining life prediction module operable to generate a predicted remaining lifetime of the insulated component using the predicted rates of corrosion and on-stream inspection data. The system further includes an alarm communicatively coupled to the corrosion modeling engine and operable to alert an operator that the predicted rate of corrosion, the predicted remaining lifetime, or a combination thereof is within a pre-determined threshold.

### FIELD OF THE DISCLOSURE

The present disclosure relates generally to pressurized oil and gas equipment and, more particularly, to corrosion modeling and prediction for insulated equipment.

### BACKGROUND OF THE DISCLOSURE

Chemical and petrochemical processing plants can commonly include thousands of process vessels and pipe segments for transport and treatment of various fluids. The intricate network of pipes, tanks, and vessels is commonly insulated to limit heat transfer, increase acoustic attenuation, and provide a fire-resistant coating. However, the inclusion of the insulation on corrodible segments can obscure the surface and can prevent visual inspections for corrosion. As aerated water and condensation accrue underneath the insulation, the equipment can begin corroding while the insulation hides the extent of the damage until failure occurs. Further compounding factors that can control the corrosion rate of the insulated equipment can include operating temperatures, insulation types, salt contaminants, and inspection practices. The failure of one segment in a processing plant, due to these factors, can expose personnel to harmful fluids, while also causing plant-wide downtime for maintenance and repairs.

Conventional techniques have been developed for the detection of corrosion on insulated equipment, such as general visual inspection and non-destructive testing methods. General visual inspection techniques can be used for identifying insulation damage and wetness, which can be followed by close visual inspections involving stripping of the insulation. Non-destructive testing techniques can include the use of radiography, ultrasonic and thermal testing, and other sensing techniques, but can further necessitate close visual inspections and insulation stripping as well. However, the intricate network of pipes, as well as the various elevation changes found in a common chemical plant, can make the visual inspection of each pipe, tank, and vessel costly and infeasible. The stripping and visual inspection of the equipment can lead to downtime within the system or plant, as equipment shutdown is performed for safety and quality reasons. Further, these inspection methods can produce large errors in identifying corrosion under insulation, particularly when using damaged insulation as a sign of corrosion, and thus can cause downtime without identifying any corroded equipment.

Accordingly, systems and methods for modeling and predicting corrosion under insulation are desirable to maintain extensive pipe, tank, and vessel networks in a cost-efficient and data-driven manner.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a computer-implemented method for predicting corrosion under insulation for a network of insulated pipes, vessels, and tanks includes receiving real-time sensor data comprising an operating pressure and temperature for an insulated component, and an ambient temperature and relative humidity for a surrounding environment, generating a dew point temperature from the real-time sensor data, comparing the operating temperature to the dew point temperature to generate a predicted rate of corrosion under insulation, and visualizing the predicted rate of corrosion under insulation to an operator on a connected display.

In a further embodiment, a system for predicting corrosion under insulation for a network of insulated pipes, vessels, and tanks includes a corrosion modeling engine operable to receive sensor data and generate predicted rates of corrosion. The corrosion modeling engine includes a corrosion rate calculation module operable to compare an operating temperature of an insulated component to a dew point temperature of a surrounding environment to generate a predicted rate of corrosion, and a remaining life prediction module operable to generate a predicted remaining lifetime of the insulated component using the predicted rates of corrosion and on-stream inspection data. The system further includes an alarm communicatively coupled to the corrosion modeling engine and operable to alert an operator that the predicted rate of corrosion, the predicted remaining lifetime, or a combination thereof is within a pre-determined threshold.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of an example system for predicting corrosion under insulation for a network of insulated pipes, according to one or more embodiments of the present disclosure.

FIG. 2 is a schematic view of a corrosion modeling engine of the modeling system of FIG. 1, according to one or more embodiments of the present disclosure.

FIG. 3 illustrates an example corrosion prediction plot output from a visualization module of the corrosion modeling engine of FIG. 2, according to one or more embodiments of the present disclosure.

FIG. 4 illustrates a method for predicting corrosion under insulation for a network of insulated pipes, according to one or more embodiments of the present disclosure.

FIG. 5 illustrates one example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to insulated oil and gas equipment and, more particularly, to corrosion modeling and prediction for insulated equipment. Embodiments disclosed herein include systems and methods for generating a predicted rate of corrosion and a predicted remaining lifetime of each insulated pipe and vessel within a network of insulated pipes. The disclosed embodiments can enable the real-time monitoring of corrosion under insulation within the network of insulated pipes, and can further enable alerting an operator when an insulated pipe or vessel is in danger of failure. The systems and methods disclosed herein can include modules for validation of the predicted rate of corrosion, and can enable the ranking of each insulated pipe and vessel in the network of insulated pipes based upon a risk of failure. The disclosed embodiments can predict and monitor the health of the network of insulated pipes with high accuracy, and can limit unnecessary visual inspections. The systems and methods disclosed herein can accordingly enable efficient, data-driven monitoring and maintenance for the network of insulated pipes, while providing an operator with real-time analytics for the network of insulated pipes, vessels, and the surrounding environment.

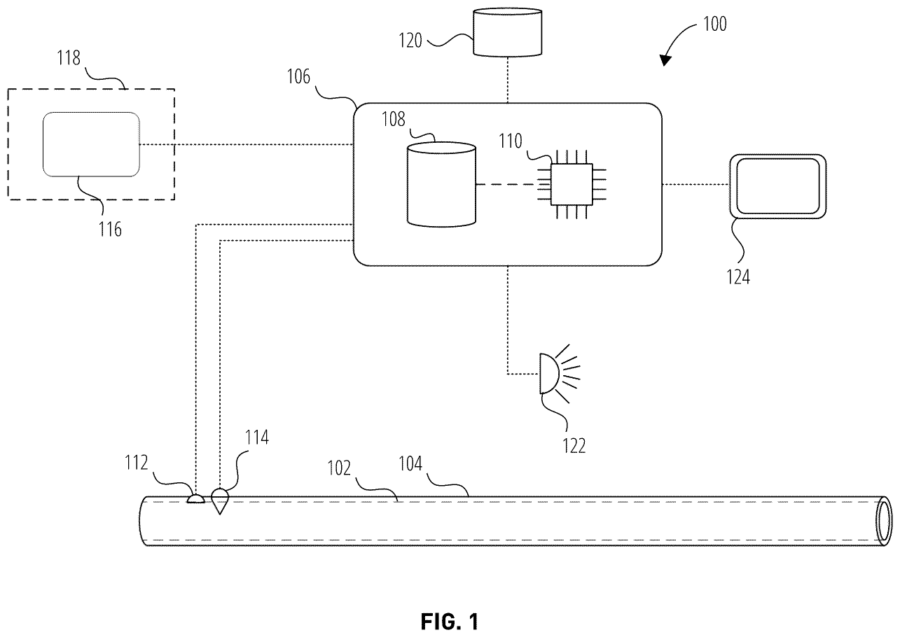

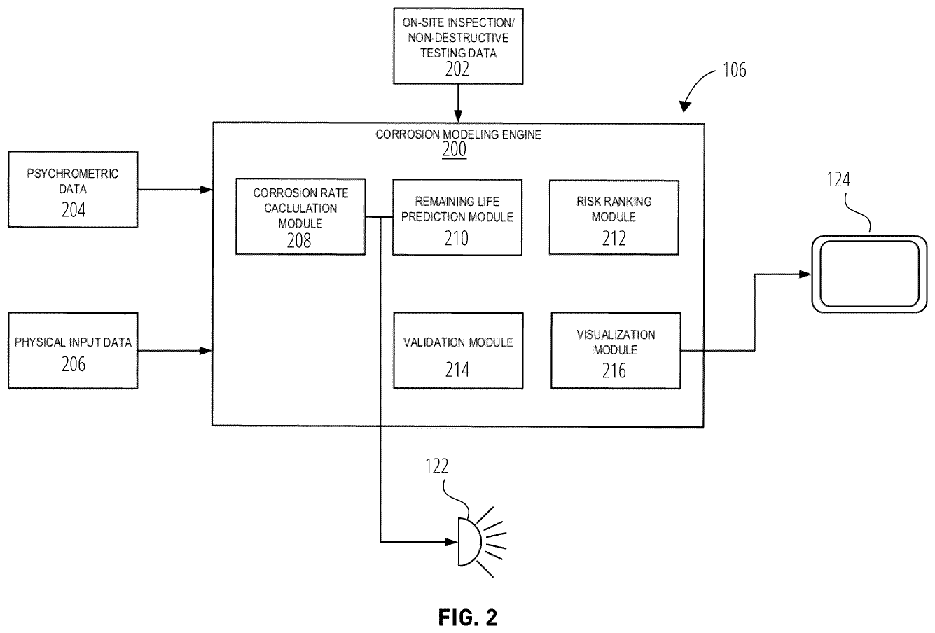

FIG. 1 is a schematic view of an example system 100 for predicting corrosion under insulation for a network of insulated pipes, according to one or more embodiments of the present disclosure. The system 100 can be installed at or near an insulated component 102, which can be a single pipe, vessel, or tank of a larger network of insulated pipes, vessels, and tanks. The insulated component 102 can include a layer of insulation 104 on an external circumferential surface thereof, such that the insulated component 102 is isolated from the surrounding environment For monitoring and prediction of failure of the insulated component 102, the system 100 can include a modeling system 106 operable to generate a predicted rate of corrosion and predicted remaining lifetime for the insulated component 102. In some embodiments, the modeling system 106 can be a computing device that includes a memory 108 and a processor 110 for storage and performance of machine-readable instructions, respectively. The memory 108 can store an engine (e.g., the corrosion modeling engine 200 of FIG. 2) any modules thereof, and can be communicably coupled to the processor 110 for execution.

The modeling system 106 can be in communication with a plurality of data sources and external components operable to provide data to the modeling system 106 for the prediction of corrosion rates and remaining lifetimes of the insulated component 102. In some embodiments, the modeling system 106 can be in communication with a surface sensor 112 mounted to an external circumferential surface of the insulated component 102. In these embodiments, the surface sensor 112 can be mounted underneath insulation 104 to provide sensor readings related to the health of the insulated component 102, as well as temperatures and moisture contents between the external surface of insulated component 102 and insulation 104. In further embodiments, the modeling system 106 can be in communication with an embedded sensor 114 that can be at least partially embedded into the insulated component 102. The embedded sensor 114 can provide similar readings and data to the surface sensor 112, but can further enable the determination of flow characteristics within the insulated component 102, such as fluid pressure and temperature. Regardless of the placement of the surface sensor 112 or embedded sensor 114, in a non-limiting example, these sensors can be selected from the group consisting of flow sensors, ultrasonic sensors, strain gauges, thermistors, moisture sensors, and any combination thereof.

In some embodiments, the modeling system 106 can be in further communication with one or more psychrometric sensors 116 operable to detect and signal parameters related to the surrounding environment. In these embodiments, the psychrometric sensors 116 can be located at an external location 118 away from the insulated component 102 or the modeling system 106. The psychrometric sensors 116 can provide environmental variables such as ambient temperatures and relative humidities for the surrounding environment. In some embodiments, the modeling system 106 can be in further communication with an on-stream inspection database 120 to receive data relating to the inherent characteristics of the insulated component 102, such as the wall thickness or minimum thickness thereof. The on-stream inspection database 120 can be in further communication with additional on-stream inspection sensors for providing additional data to modeling system 106, such that any non-destructive testing results can be stored therein.

The modeling system 106 can be in communication with various alerting components at or near the insulated component 102, which can be utilized in notifying an operator of the status of the insulated component 102 and alert the operator if the insulated component 102 is at risk of failure. The modeling system 106 can be in communication with an alarm 122 that can be operable to alert nearby personnel of a risk of failure in the insulated component 102, and can thus signal for repair or maintenance of the insulated component 102. The modeling system 106 can provide a signal to the alarm 122 when the predicted rate of corrosion or predicted remaining lifetime of the insulated component 102 is within a pre-determined threshold that can signal impending failure. The alarm 122 can further signal unsafe operating conditions, or operating conditions that can directly lead to corrosion under insulation in the insulated component 102. In further embodiments, the modeling system 106 can be in communication with a connected display 124 operable to display visualized information and data to an operator. The connected display 124 can be utilized in displaying the predicted rate of corrosion, predicted remaining lifetime, the risk of failure for the insulated component 102, the risk of failure for each insulated component 102 in the network of insulated pipes, validation of the predicted rate of corrosion, and various other results determined via the modeling system 106.

FIG. 2 is a schematic view of a corrosion modeling engine 200 of the modeling system 106, according to one or more embodiments of the present disclosure. As shown in FIG. 1, the modeling system 106 is in communication with a plurality of data sources that can be utilized in the determination of predicted rates of corrosion and predicted remaining lifetimes of insulated component 102, or any of the pressure vessels, tanks and pipes within an oil and gas and petrochemical systems, as discussed above. The corrosion modeling engine 200 can be stored within the memory 108 of FIG. 1, and similarly executed via the processor 110 of FIG. 1. The corrosion modeling engine 200 can receive the data from the various sources for the calculation of predicted rates of corrosion, predicted remaining lifetimes, and other operational insights for the insulated component 102. In some embodiments, the corrosion modeling engine 200 can receive one or more of the on-stream inspection/nondestructive testing data (OSI/NDT) data 202, the psychrometric data 204, and the physical input data 206 for the prediction risk of failure for the insulated component 102.

In some embodiments, the corrosion modeling engine 200 can include a corrosion rate calculation module 208 operable to receive to an operating temperature of the insulated component 102 and a psychrometric data of the surrounding environment to generate a predicted rate of corrosion. The corrosion rate calculation module 208 can first calculate a dew point temperature for the surrounding environment using the received psychrometric data, such as the ambient temperature and relative humidity. The corrosion rate calculation module 208 can further compare the dew point temperature to the operating temperature of the insulated component 102 to generate a predicted rate of corrosion. In some embodiments, the corrosion rate calculation module 208 can further determine if the insulated component 102 is within dry or wet operating conditions, and can tune the generation of the predicted rate of corrosion based upon these operating conditions.

The corrosion modeling engine 200 can further include a remaining life prediction module 210 operable to generate a predicted remaining lifetime for the insulated component 102 of interest. In some embodiments, the remaining life prediction module 210 can receive a minimum thickness and an initial thickness of the insulated component 102 from the OSI/NDT data 202. The remaining life prediction module 210 can accordingly use this thickness data along with the predicted rate of corrosion to determine an estimated time until the actual thickness of the insulated component 102 has corroded to be at or under the minimum thickness. This estimated time can represent the predicted remaining lifetime for the insulated component 102 based upon the current operating conditions and the predicted rate of corrosion.

In some embodiments, the corrosion modeling engine 200 can further include a risk ranking module 212 operable to rank a plurality of the insulated components 102 based upon their risk of failure. The risk ranking module 212 can receive a predicted rate of corrosion and a predicted remaining lifetime for each insulated component 102 of the network of insulated pipes, and can accordingly classify each insulated component 102 based upon the severity of the risk of failure. In a non-limiting example, high risk insulated components 102 can be considered those with a predicted rate of corrosion greater than 10 milli-inches per year (MPY) or those with less than four years of predicted remaining lifetime. Each insulated component 102 can be classified and ranked in order of severity of risk of failure, and can thus be used to prioritize inspection, maintenance, repair, or replacement thereof. Using the various inputs 202-206, the risk ranking module 212 can perform and update the risk ranking of each insulated component 102 in real-time to provide constant monitoring of the network of insulated pipes.

The corrosion modeling engine 200 can further include a validation module 214 operable to receive inspection data from the OSI/NDT data 202 and compare this data to the predicted rate of corrosion for an insulated component 102 of interest. The validation module 214 can compare the actual rate of corrosion determined via inspection to the predicted rate of corrosion generated via the corrosion modeling engine 200. The validation module 214 can utilize the actual and predicted rates of corrosion to validate the calculations and assumptions of the corrosion modeling engine 200. In some embodiments, the validation module 214 can provide an operator with an error value or accuracy value for the corrosion modeling engine 200, such that the corrosion modeling engine 200 can be used with confidence in the predicted rate of corrosion and predicted remaining lifetime. In a non-limiting example, the use of the corrosion modeling engine 200 for generating a predicted rate of corrosion can be sampled across the network of insulated pipes and show a greater than 98% agreement with the actual rate of corrosion.

In some embodiments, the corrosion modeling engine 200 can further include a visualization module 216 operable to receive and visualize a predicted rate of corrosion, a predicted remaining lifetime, a plurality of risk classifications, a validation output, or a combination thereof. The visualization module 216 can be in communication with the connected display 124, and can provide visualized results to the connected display 124 for display to an operator. As such, the visualization module 216 can enable viewing and manipulation of the predictions and validations generated via the corrosion modeling engine 200. In further embodiments, one or more modules of the corrosion modeling engine 200 can be in communication with the alarm 122. In a non-limiting example, any of the corrosion rate calculation module 208, the remaining life prediction module 210, and the prediction module 214 can provide a signal to the alarm 122 when the predicted rate of corrosion or predicted remaining lifetime are within a pre-determined threshold. The pre-determined threshold can represent a value for the remaining lifetime or rate of corrosion that can lead to imminent failure of an insulated component 102, or can represent unfavorable operating conditions wherein the predicted rate of corrosion is actively degrading the network of insulated pipes. The alarm 122 can accordingly alert an operator to the imminent failure or unsafe conditions, and can further advise a location or insulated component 102 of interest to be inspected, repaired, or replaced.

The use of modeling system 106, and particularly the corrosion modeling engine 200, can enable the real-time monitoring of the health of a network of insulated pipes. The corrosion modeling engine 200 can provide predicted rates of corrosion, predicted remaining lifetimes, risk-ranked data, and validations of the performed calculations to limit failures and downtime for the network of insulated pipes, and any larger system in which they are included. The corrosion modeling engine 200 can visualize results and alert operators to both current conditions and dangerous conditions within each insulated component 102 of the network of insulated pipes. The corrosion modeling engine 200 can further provide a maintenance roadmap through the risk-ranked data, such that the highest-risk insulated components 102 can be addressed before failure.

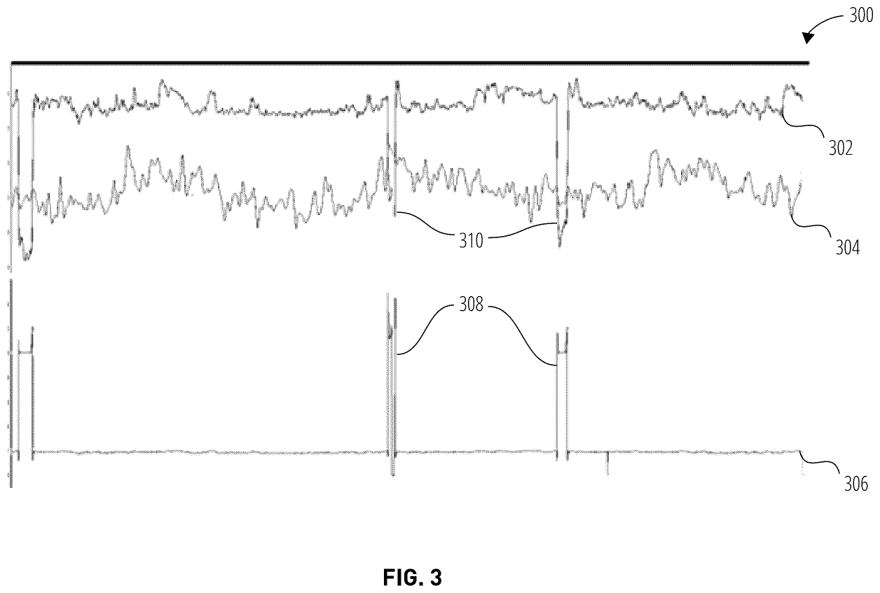

FIG. 3 illustrates an example corrosion prediction plot 300 output from the visualization module 216 of the corrosion modeling engine 200 of FIG. 2, according to one or more embodiments of the present disclosure. The example corrosion prediction plot 300 can represent the evolution of the operating temperature 302 and the dew point temperature 304 overtime, based upon the input data for the corrosion modeling engine 200 of FIG. 2. In the illustrated embodiment, the calculated dew point temperature 304 can be compared directly to the operating temperature 302, as is performed in the corrosion rate calculation module 208 of FIG. 2. As such, the comparison between the operating temperature 302 and the dew point temperature 304 can be used in visualization of the corrosion rate 306, shown below on the same plot. As can be seen in the illustrated embodiment, the corrosion rate 306 can include a plurality of corrosion spikes 308 in which the insulated component 102 of interest can be seen to be actively corroding. These corrosion spikes 308 can correspond to temperature inversions 310 of the operating temperature 302 dropping below the dew point temperature 304, thus signifying that condensation has formed under the insulation 104 of FIG. 1, thus enabling corrosion of the insulated component 102.

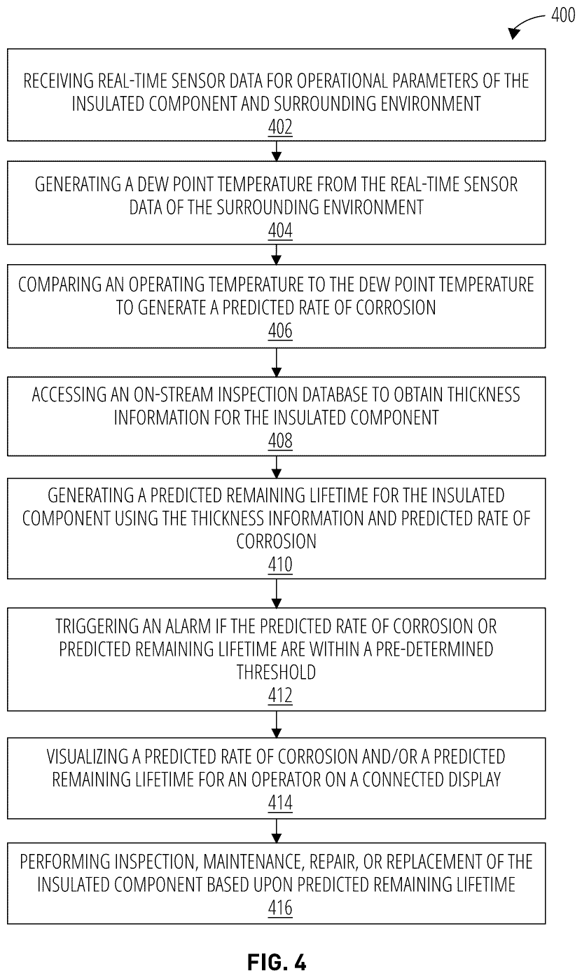

In view of the structural and functional features described above, example methods will be better appreciated with reference to FIG. 4. While, for purposes of simplicity of explanation, the example methods of FIG. 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 4 illustrates a method 400 for predicting corrosion under insulation for a network of insulated pipes, vessels, and tanks, according to one or more embodiments of the present disclosure. The method 400 can be implemented by the system 100, as shown in FIG. 1. As such, reference may be made to the examples of FIGS. 1-2 in the description of the method 400. The method 400 can begin at 402 with receiving real-time sensor data comprising an operating pressure and temperature (e.g., from surface sensor 112 or embedded sensor 114) for an insulated component (e.g., the insulated component 102), and an ambient temperature and relative humidity for a surrounding environment (e.g., from psychrometric sensors 116). The real-time sensor data can be received within a modeling system (e.g., the modeling system 106) to perform predictions of corrosion rates and remaining lifetimes for the insulated component of interest.

The method 400 can further include generating a dew point temperature from the real-time sensor data at 404. In some embodiments, a corrosion rate calculation module (e.g., the corrosion rate calculation module 208) can calculate the dew point temperature using the ambient temperature and relative humidity of the surrounding environment. The method 400 can continue at 406 with comparing the operating temperature of the insulated component to the dew point temperature of the surrounding environment to generate a predicted rate of corrosion under insulation (e.g., the insulation 104) for the insulated component. The predicted rate of corrosion can account for a duration and severity of accumulated condensation that can occur during temperature inversions in which the operating temperature drops below the dew point temperature. In some embodiments, the method 400 can further include determining, based upon the real-time sensor data, if the insulated component is under dry conditions or wet conditions and tuning generation of the predicted rate of corrosion based upon the presence of dry conditions or wet conditions.

The method 400 can continue at 408 with accessing an on-stream inspection database (e.g., the on-stream inspection database 120) to obtain a minimum thickness for the insulated component and an initial thickness for the insulated component. The minimum thickness can represent the minimum safe thickness at which the insulated component can operate without failure, while the initial thickness can be a manufacturer-defined value, or a value obtained from non-destructive testing. Using these thickness values, the method 400 can continue at 410 with generating a predicted remaining lifetime of the insulated component using the predicted rate of corrosion, the minimum thickness, and the initial thickness of the insulated component. In some embodiments, a remaining life prediction module (e.g., the remaining life prediction module 210) can generate the predicted remaining lifetime using a difference between the minimum thickness and initial thickness of the insulated component compared to the predicted rate of corrosion. As such, the remaining life prediction module can predict how long it can take for the insulated component to corrode to be within the minimum thickness at which repair or replacement can be necessitated.

As such, the method 400 can continue at 412 with triggering an alarm (e.g., the alarm 122) to alert an operator that the predicted rate of corrosion, the predicted remaining lifetime, or a combination thereof is within a pre-determined threshold. As discussed above, the predicted remaining lifetime can determine the time until the insulated component is within the minimum thickness for operation. The alarm can accordingly alert an operator of imminent failure or unsafe operating conditions leading to excessive corrosion of one or more insulated components in a network of insulated pipes, tanks, and vessels. The method 400 can further include visualizing the predicted rate of corrosion under insulation to an operator on a connected display (e.g., the connected display 124). In some embodiments, a visualization module (e.g., the visualization module 216) can visualize any of the calculated or predicted values for view by an operator, such as the example corrosion prediction plot 300 of FIG. 3).

Based upon the visualized values and the alarm notifications, the method 400 can continue at 416 with performing close-visual inspection, maintenance, repair, replacement, or a combination thereof on the insulated component. The method 400 can enable real-time monitoring of a network of insulated pipes, and based upon the operating conditions and predicted remaining lifetime of each insulated component, the method 400 can direct the maintenance operations for the network of insulated pipes. In some embodiments, a risk ranking module (e.g., the risk ranking module 212) can classify a risk of failure using the predicted rate of corrosion and predicted remaining lifetime for each insulated component of the network of insulated pipes. The risk ranking module can classify each insulated component based upon the risk of failure, and can direct an operator to perform maintenance starting with the most at-risk insulated components.

During maintenance operations or visual close-visual inspection of the insulated components, the method 400 can further include performing non-destructive testing to determine an actual rate of corrosion for the insulated component. In some embodiments, a validation module (e.g., the validation module 214) can compare the predicted rate of corrosion and the actual rate of corrosion for the insulated component to validate the predicted rate of corrosion. The validation module can calculate an error or accuracy of the method 400 at predicting the corrosion rate and remaining lifetime, such that an operator can trust the values generated within the method 400. The method 400 can further include storing, in the on-stream inspection database, the predicted rate of corrosion and the actual rate of corrosion for the insulated component, such that these values can be accessed as historical data or for time-averaging of the corrosion rate and remaining lifetimes.

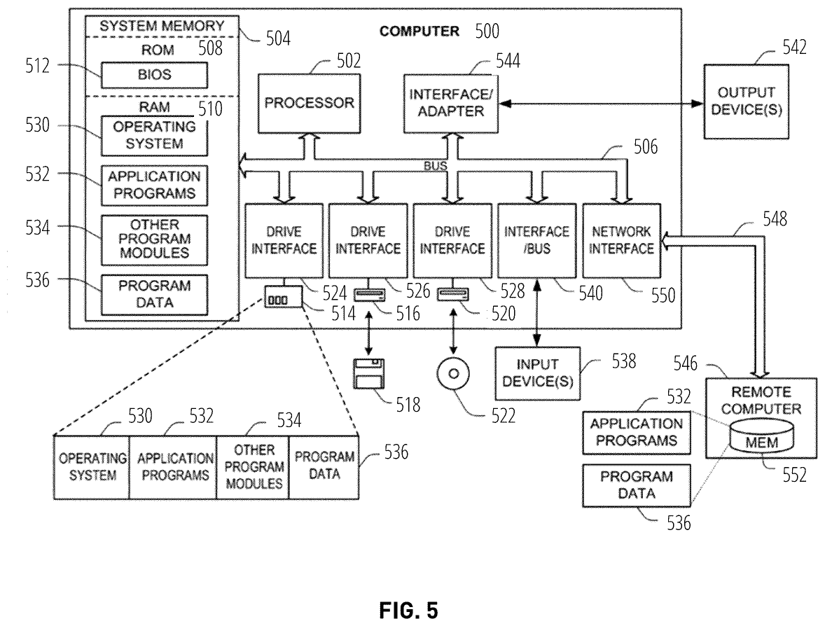

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 5 illustrates one example of a computer system 500 that can be employed to execute one or more embodiments of the present disclosure. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 502, system memory 504, and system bus 506 that couples various system components, including the system memory 504, to processing unit 502. System memory 504 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 508 and random-access memory (RAM) 510. A basic input/output system (BIOS) 512 can reside in ROM 508 containing the basic routines that help to transfer information among elements within computer system 500.

Computer system 500 can include a hard disk drive 514, magnetic disk drive 516, e.g., to read from or write to removable disk 518, and an optical disk drive 520, e.g., for reading CD-ROM disk 522 or to read from or write to other optical media. Hard disk drive 514, magnetic disk drive 516, and optical disk drive 520 are connected to system bus 506 by a hard disk drive interface 524, a magnetic disk drive interface 526, and an optical drive interface 528, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 508, including operating system 530, one or more application programs 532, other program modules 534, and program data 536. In some examples, the application programs 532 can include the corrosion rate calculation module 208, remaining life prediction module 210, risk ranking module 212, prediction module 214, validation module 214, and visualization module 216, and the program data 536 can include any of the OSI/NDT data 202, the psychrometric data 204, the physical input data 206, the generated predictions, and any combination thereof. The application programs 532 and program data 536 can include functions and methods programmed to predict corrosion under insulation and a remaining lifetime for each insulated component 102 of a network of insulated pipes, such as shown and described herein.

A user may enter commands and information into computer system 500 through one or more input device 538, such as a pointing device (e.g., a mouse, touch screen), keyboard, microphone, joystick, game pad, scanner, and the like. These and other input devices 538 are often connected to processing unit 502 through a corresponding port interface 540 that is coupled to the system bus, but may be connected by other interfaces, such as a parallel port, serial port, or universal serial bus (USB). One or more output devices 542 (e.g., display, a monitor, printer, projector, or other type of displaying device) is also connected to system bus 506 via interface 544, such as a video adapter.

Computer system 500 may operate in a networked environment using logical connections to one or more remote computers, such as remote computer 546. Remote computer 546 may be a workstation, computer system, router, peer device, or other common network node, and typically includes many or all the elements described relative to computer system 500. The logical connections, schematically indicated at 548, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 500 can be connected to the local network through a network interface or adapter 550. When used in a WAN networking environment, computer system 500 can include a modem, or can be connected to a communications server on the LAN. The modem, which may be internal or external, can be connected to system bus 506 via an appropriate port interface. In a networked environment, application programs 532 or program data 536 depicted relative to computer system 500, or portions thereof, may be stored in a remote memory storage device 552.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A computer-implemented method for predicting corrosion under insulation for a network of insulated pipes, vessels, and tanks, the method comprising:
receiving real-time sensor data comprising an operating pressure and temperature for an insulated component, and an ambient temperature and relative humidity for a surrounding environment;
generating a dew point temperature from the real-time sensor data;
comparing the operating temperature to the dew point temperature to generate a predicted rate of corrosion under insulation; and
visualizing the predicted rate of corrosion under insulation to an operator on a connected display.

2. The computer-implemented method of claim 1, further comprising:
performing close-visual inspection, maintenance, repair, replacement, or a combination thereof on the insulated component.

3. The computer-implemented method of claim 1, further comprising:
accessing an on-stream inspection database to obtain a minimum thickness for the insulated component and an initial thickness for the insulated component.

4. The computer-implemented method of claim 3, further comprising:
generating a predicted remaining lifetime of the insulated component using the predicted rate of corrosion, the minimum thickness, and the initial thickness of the insulated component.

5. The computer-implemented method of claim 4, further comprising:
monitoring the predicted rate of corrosion and the predicted remaining lifetime of the insulated component in real-time; and
triggering an alarm to alert an operator that the predicted rate of corrosion, the predicted remaining lifetime, or a combination thereof is within a pre-determined threshold.

6. The computer-implemented method of claim 4, further comprising:
classifying a risk of failure using the predicted rate of corrosion and predicted remaining lifetime for each insulated component of the network of insulated pipes, vessels, and tanks.

7. The computer-implemented method of claim 1, further comprising:
determining, based upon the real-time sensor data, if the insulated component is under dry conditions or wet conditions; and
tuning generation of the predicted rate of corrosion based upon the presence of dry conditions or wet conditions.

8. The computer-implemented method of claim 1, further comprising:
performing non-destructive testing to determine an actual rate of corrosion for the insulated component;
comparing the predicted rate of corrosion and the actual rate of corrosion for the insulated component to validate the predicted rate of corrosion; and
storing, in an on-stream inspection database, the predicted rate of corrosion and the actual rate of corrosion for the insulated component.

9. A system for predicting corrosion under insulation for a network of insulated pipes, vessels, and tanks, the system comprising:
a corrosion modeling engine operable to receive sensor data and generate predicted rates of corrosion, the corrosion modeling engine including:
a corrosion rate calculation module operable to compare an operating temperature of an insulated component to a dew point temperature of a surrounding environment to generate a predicted rate of corrosion, and
a remaining life prediction module operable to generate a predicted remaining lifetime of the insulated component using the predicted rates of corrosion and on-stream inspection data; and
an alarm communicatively coupled to the corrosion modeling engine and operable to alert an operator that the predicted rate of corrosion, the predicted remaining lifetime, or a combination thereof is within a pre-determined threshold.

10. The system of claim 9, wherein the corrosion modeling engine further comprises a risk ranking module operable to classify a risk of failure for each insulated component of the network of insulated pipes, vessels, and tanks using the predicted rate of corrosion and predicted remaining lifetime of each insulated component.

11. The system of claim 9, further comprising an on-stream inspection database communicatively coupled to the corrosion modeling engine and providing the on-stream inspection data to the remaining life prediction module.

12. The system of claim 9, further comprising a connected display communicably coupled to the corrosion modeling engine, wherein the corrosion modeling engine further comprises a visualization module operable to visualize the predicted rate of corrosion and predicted remaining lifetime for display to an operator on the connected display.

13. The system of claim 9, further comprising one or more sensors selected from the group consisting of embedded sensors included within the insulated component, surface sensors mounted on an external surface of the insulated component, psychrometric sensors operable to obtain data regarding the surrounding environment, and any combination thereof.

14. The system of claim 9, wherein the corrosion rate calculation module is further operable to determine whether the insulated component is operating in a dry or a wet condition, and tunes generation of the predicted rate of corrosion based upon the dry or wet condition.

15. The system of claim 9, further comprising a validation module operable to receive an actual rate of corrosion from non-destructive testing results and compare the actual rate of corrosion to the predicted rate of corrosion for validation of the corrosion modeling engine.
